(19) United States
(12) Patent Application Publication
(10) Pub. No.: US 2019/0152155 A1
(43) Pub. Date: May 23, 2019

(54) 3D PRINTING

(71) Applicant: HEWLETT-PACKARD DEVELOPMENT COMPANY, L.P., Houston, TX (US)

(72) Inventors: Sergio Gonzalez, Sant Cugat del Valles (ES); Yngvar Rossow, Sant Cugat del Valles (ES); Jordi Gonzalez, Sant Cugat del Valles (ES)

(21) Appl. No.: 16/097,585

(22) PCT Filed: Jul. 27, 2016
(86) PCT No.: PCT/US2016/044188

§ 371 Date: Oct. 29, 2018

(51) Int. Cl. B29C 64/393; B33Y 50/02; B29C 64/357; B29C 64/153

(52) U.S. Cl. CPC B29C 64/393; B29C 64/153; B29C 64/357; B33Y 50/02

(57) ABSTRACT

A controller for an additive manufacturing system comprises a processor to: receive data associated with a 3D printing job to generate at least one 3D object using one or more materials; determine, based on the received data, at least one operational parameter to be used by the additive manufacturing system in completing the 3D printing job; calculate, based on the received data, a value of at least one geometric parameter associated with the 3D printing job; and for at least one of the one or more materials, determine, based on the determined at least one operational parameter and the calculated value of the at least one geometric parameter, an amount of the at least one material to be used by the additive manufacturing system to complete the 3D printing job.

### BACKGROUND

Apparatus, including those commonly referred to as “3D printers”, have been proposed as a potentially convenient way to produce three-dimensional objects. These apparatus typically receive a definition of the three-dimensional object in the form of an object model, or data derived from an object model. This object model (or data derived therefrom) is processed to form instructions, which control the apparatus to produce the object using at least one production material. Depending on the type of 3D printer, these production materials may comprise a combination of agents and powdered build materials, and/or liquid solutions of production material. The processing of an object model (or data derived therefrom) may be performed on a layer-by-layer basis. It may be desired to produce a three-dimensional object with at least one property, such as color, mechanical and/or structural properties. The processing of the object model (or data derived therefrom) may vary based on the type of apparatus and/or the production technology being implemented. Generating objects in three-dimensions presents many challenges that are not present with two-dimensional print apparatus.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a schematic view of an example controller or an additive manufacturing system;

FIG. 2 is a schematic view of an example additive manufacturing system;

FIG. 3 is a schematic view of an example additive manufacturing system during manufacturing of a 3D object;

FIG. 4 is a schematic view of an example additive manufacturing system during manufacturing of a 3D object;

FIG. 5 is a flow diagram that outlines an example method for determining an amount of at least one material required by an additive manufacturing system to complete a 3D printing job; and

FIG. 6 is a schematic view of an example computer readable memory.

### DETAILED DESCRIPTION

3D printing generally involves generating a 3D geometric representation of at least one object to be printed (i.e., manufactured by a 3D printer). Such a 3D geometric representation may be referred to as an object model. An object model may be stored in a 3D data file using a specific file format. An object model may also define at least one material to be used to form the object. In some examples an object model may define a first material to be used to form a first portion of an object and a second material to be used to form a second portion of that object. The 3D data file may be processed to generate instructions that are processed by a 3D printing system for reproducing the object. There are a variety of solutions for processing information in a 3D data file as well as to enable a user to define how an object should be manufactured using a 3D printing system.

The printing of a 3D build job comprising the generation of at least one 3D object can take a number of hours. Therefore, sometimes a user may wish to leave an apparatus unattended during some or all of the printing of a given 3D build job. Moreover, it may not be possible or desirable to replenish the supplies of production materials to be used for the 3D build job during printing. It may therefore be desirable to ensure that the apparatus has access to sufficient supplies of production materials to complete a given 3D build job before starting the printing of that job. The amount of each type of production material used in a given 3D build job depends on various factors including the volume of a print chamber in which 3D objects are to be generated, the size and shape of the 3D objects to be generated, the type of the production material, fusing temperature, print mode, and so on. An amount of a material which is to be used to complete a given 3D print job is hereinafter referred to as a “to-be-used amount” of that material. A “to-be-used” amount of a material should be understood to be the total amount of that material consumed during the performance of a given 3D print job.

Thus, in 3D printing there is a challenge to accurately estimate the amount of consumable materials to be used by a given 3D build job.

Certain examples described herein enable a 3D printing system to estimate the amount of a given material to be used to complete a given 3D printing job. Such an estimation may be performed before starting to generate a 3D object associated with the 3D printing job, enabling a user to ensure that the 3D printing system is provided with sufficient material to complete the job without further user intervention.

As used herein, an object refers to a 3D object to be individually built, or actually built, by a 3D printing system. An object, as referred herein, is built by successively adding layers so as to form an integral piece. A 3D model may include a polygon mesh defining an object. A polygon mesh refers to a collection of vertices, edges, and faces defining the shape of a polyhedral object in a 3D model. The faces may be formed as polygons such as, but not limited to, triangles. An object may include void spaces embedded in the object body.

As used herein, an operational parameter refers to a parameter, or set of parameters, that defines how an object is to be generated by a 3D printing system. For example, an operational parameter may comprise at least one of: type of powdered build material to be used to generate the 3D object, operating mode of the 3D printing system, number of printing passes by layer to be performed when generating the 3D object, print density of each printing pass, height of each layer of build material, volume of powdered build material to be used for print head maintenance processes, and the like. An operational parameter may be comprised in or defined by a print mode or print setting. A print mode may comprise or define a set of operational parameters. An operational parameter may be user selected. The operational parameter(s) to be used by an additive manufacturing system in completing a given 3D printing job may be specified in data associated with that 3D printing job (e.g. in at least one file header).

As used herein, a geometric parameter refers to a parameter, or set of parameters, that defines a geometric property (that is, a property relating to shape, size and/or configuration) of an object to be generated by a 3D printing process (that is, an object associated with a given 3D printing job). For example, a geometric parameter may comprise at least one of: volume of a bounding box associated with the 3D printing job; volume of an object associated with the 3D printing job; volumetric surface area of an object associated with the 3D printing job, and the like. A geometric parameter may be derivable from print data associated with the 3D printing job. In some examples the geometric parameter may be derivable from a 3D object model associated with the 3D printing job. In some examples the geometric parameter may be derivable from object slice data associated with the 3D printing job.

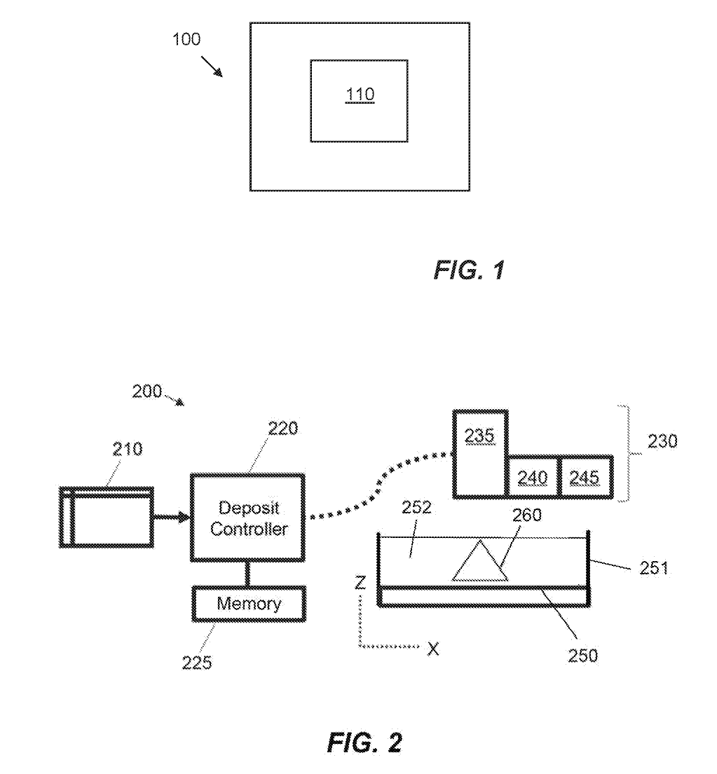

FIG. 1 is a schematic diagram of a controller 100 for an additive manufacturing system (not shown). The controller comprises a processor 110. The processor 110 is to receive data associated with a 3D printing job, the 3D printing job being to generate at least one 3D object using one or more materials. The processor 110 is also to determine, based on the received data, at least one operational parameter to be used by the additive manufacturing system in completing the 3D printing job. The processor 110 is also to calculate, based on the received data, a value of at least one geometric parameter associated with the 3D printing job. The processor is also to determine, for at least one of the one or more materials, based on the determined at least one operational parameter and the calculated value of the at least one geometric parameter, an amount of the at least one material to be used by the additive manufacturing system to complete the 3D printing job.

In some examples, e.g. examples in which the 3D printing job is to generate the at least one 3D object using a plurality of materials (e.g. at least one powdered build material and at least one agent), the processor 110 is to determine an amount to be used by the additive manufacturing system to complete the 3D printing job of each of the one or more materials. Such examples may be suitable for unattended 3D printing processes. Alternatively, in some examples in which the 3D printing job is to generate the at least one 3D object using a plurality of materials, the processor 110 may be to determine an amount to be used by the additive manufacturing system to complete the 3D printing job of at least one but not all of the plurality of materials. Such examples may be employed, for example, when it is not possible (for example due to the nature of the additive manufacturing system) to replenish the supply of the at least one material for which the processor is to determine a required amount during generation of the 3D object. It may be possible to replenish the supply of some materials during generation of a 3D object, depending on the nature of the additive manufacturing system.

In examples in which a plurality of 3D objects are associated with a given 3D printing job, the processor 110 may be to calculate a value for the least one geometric parameter in respect of each 3D object associated with the 3D printing job. In such examples the processor 110 may be to add together the calculated values to generate an overall value of the at least one geometric parameter, and may use the overall value in determining an amount of the at least one material to be used by the additive manufacturing system to complete the 3D printing job. Alternatively, the processor 110 may be to determine an individual value for the required amount of the at least one material in respect of each individual 3D object associated with the 3D printing job, and may add together the determined individual values to generate an overall value for the to-be-used amount of the at least one material. It will be appreciated that in both cases the final determined value for the amount of the at least one material to be used by the additive manufacturing system to complete the 3D printing job will be the same.

The determined amount may be a weight, a mass, a volume, or any other measure useable to quantify an amount of a material. In examples in which the processor 110 is to determine a to-be-used amount of a plurality of different materials, the determined amount may or may not comprise the same measure in respect of each different material. For example, the processor 110 may be to determine a to-be-used weight or mass of powdered build material and a to-be-used volume of an agent. It will be appreciated that a mass of powdered build material can be calculated from a volume of powdered build material, based on a known density of the powdered build material.

The controller 100 may be for any system for additive manufacturing of an object using at least one material. Such an additive manufacturing system may, for example, use a transformation of a 3D object as defined in 3D model into relatively thin horizontal cross-sections (not shown) and then create successive layers until the 3D object is reproduced.

FIG. 2 shows an example of an additive manufacturing system, which the controller 100 may be comprised in or connected to. FIG. 2 shows an example of an apparatus 200 arranged to produce a 3D object 260. The apparatus 200 can receive print data 210 for the 3D object. In one case, at least one portion of the apparatus 200 may be implemented as executable code, stored on a non-transitory storage medium, that includes instructions, that when executed by at least one processor, causes the processor to perform the functionality of the at least one portion of the apparatus 200 described herein. Apparatus 200 is shown and described for better understanding of the presently described examples; other apparatus of a different form and/or using a different technology may alternatively be used with the example controllers described herein.

In FIG. 2, the apparatus 200 comprises a deposit controller 220 and a memory 225. The deposit controller 220 may comprise at least one processor that forms part an embedded computing device, e.g. adapted for use in controlling an additive manufacturing system. Memory 225 may comprise volatile and/or non-volatile memory, e.g. a non-transitory storage medium, arranged to store computer program code, e.g. in the form of machine readable instructions and/or executable code that comprises instructions for at least one processor. The deposit controller 220 is communicatively coupled to aspects of the apparatus that are arranged to construct the 3D object 260. These comprise a deposit mechanism 230. The deposit mechanism 230 can deposit production materials to generate the 3D object 260. In the present case, the deposit mechanism comprises a powdered build material supply mechanism 235 and an agent ejection mechanism 240, 245. In other cases the deposit mechanism 230 may comprise fewer or additional components, e.g. a powdered build material supply mechanism may be provided separately from the agent ejection mechanism or omitted, or other components. In some examples the agent ejection mechanism is omitted, e.g. because those examples relate to additive manufacturing systems which do not use agents.

In the example of FIG. 2, the agent ejection mechanism 240, 245 comprises two components: a first component 240 for the supply of a first agent and a second component 245 for the supply of a second agent. Each of the first and the second agent may comprise, e.g., a fusing agent (also referred to as a coalescing agent), a detailing agent (also referred to as a coalescing modifier agent), a colorant, etc. For the purposes of this disclosure, an agent used in the generation of a given 3D object is considered to be a consumable material, a particular amount of which is to be used for the generation of that 3D object.

The powdered build material supply mechanism 235 can supply at least one powdered build material layer upon which agents are deposited by the agent ejection mechanism 240, 245 to produce the 3D object 260. For the purposes of this disclosure, a powdered build material used in the generation of a given 3D object is considered to be a consumable material, a particular amount of which is to be used in the process of generating that 3D object.

In the example of FIG. 2, the 3D object 260 is built layer by layer on a build surface 250. The build surface 250 forms the base of a build chamber 251. The build chamber 251 comprises a base and at least one side wall, which together define a partially enclosed build volume. The cross-section of the build volume, in a plane parallel to the build surface, is substantially constant over the height of the build chamber. In the illustrated example the build volume comprises a cuboid. The arrangement of the aspects and components shown in FIG. 2 are not limiting; the exact arrangement of each apparatus will vary according to the production technology that is implemented and the model of apparatus.

In the example of FIG. 2 the deposit controller 220 is configured to process and/or otherwise use the print data 210 to control at least one component of the deposit mechanism 230. The deposit controller 220 may control at least one of the powdered build material supply mechanism 235 and the agent ejection mechanism 240, 245. For example, the print data 210 (or instructions comprised therein) may be used by the deposit controller 220 to control the ejection of printable agents from nozzles within the agent ejection mechanism. In one implementation the apparatus 200 may be arranged to use a fusing agent and a detailing agent that are respectively supplied by the components of the agent ejection mechanism 240, 245. These agents enable a 3D object to be accurately generated, and may also allow a 3D object to have varying material properties. Generated objects may be constructed by depositing at least patterns of the fusing agent on layers of powdered build material forming z-plane slices, followed by the application of energy to bind the powdered build material, e.g. infra-red or ultra-violet light.

At least one of the powdered build material supply mechanism 235 and the agent ejection mechanism 240, 245 may be moveable relative to the build surface 250, e.g. in at least one of the x, y and z directions (wherein the y axis is into the sheet for FIG. 2). At least one of the powdered build material supply mechanism 235, the agent ejection mechanism 240, 245 and the build surface 250 may be moveable under control of the deposit controller 220 to achieve this. In other implementations the apparatus may comprise part of, amongst others, selective laser sintering systems, stereo lithography systems, fused deposition modelling systems, any 3D printing system, inkjet deposition systems and laminated object manufacturing systems. These include apparatus that directly deposit materials rather than those described that use various agents.

In some examples, the functionality of the controller 100 and the deposit controller 220 may be combined in one embedded system. This may be the case for a “stand alone” 3D printing apparatus that can receive data, e.g. by physical transfer and/or over a network, and produce an object. For example, such a stand-alone apparatus may be communicatively coupled to a computer device that can send a 3D printing job to the apparatus in the manner of a two-dimensional printer. In some such examples, the additive manufacturing system 200 may include a user console for facilitating interaction with a user. Alternatively, the controller 100 may be provided as a separate apparatus communicatively coupled to the additive manufacturing system 200.

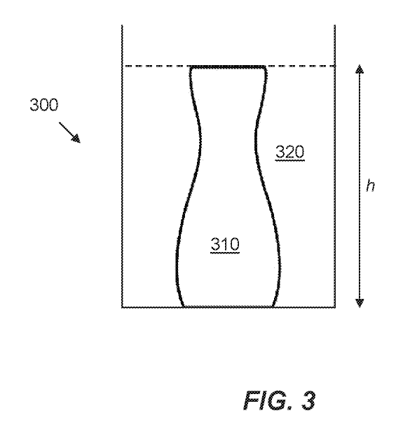

FIG. 3 shows a side view section of build chamber 300 of an additive manufacturing system (e.g. the additive manufacturing system 200), after generation of a 3D object 310 (before the 3D object has been removed from the build chamber). The build chamber 300 is for generating a 3D object using a powdered build material, for example in conjunction with a fusing agent and a detailing agent, e.g. in the manner described above. As with the build chamber 251 discussed above, the build chamber 300 comprises a base and at least one side wall, which together define a partially enclosed build volume. The build chamber is filled to a height h by the 3D object 310 (which comprises fused or solidified powdered build material) and by unfused or unsolidified powdered build material 320.

A given 3D printing job to be performed by the additive manufacturing system (that is, the additive manufacturing system comprising the build chamber 300)will be associated with a bounding box, which defines a volume which will be filled with powdered build material upon the completion of the 3D printing job. In the illustrated example, the bounding box has the same cross-section as the interior of the build chamber, and a height h, which in this example is equal to the height of the object 310. In other examples the height of the bounding box may not be equal to the height of the object 310, e.g. because at least one layer of powdered build material is deposited below or above the object 310. The object 310 has a volume and a volumetric surface area, which may each be considered to be a geometrical parameter associated with the 3D printing job. The volume of the bounding box may also be considered to be a geometrical parameter associated with the 3D printing job.

In some examples, e.g. examples in which a recyclable powdered build material is used to generate the 3D object 310, it may be useful to estimate how much of the powdered build material used in the generation of a given 3D object will be available for recycling. In the example of FIG. 3, a volume of unfused powdered build material can be calculated by subtracting the volume of the object 310 from the volume of the bounding box.

Returning to the controller 100, in some examples the at least one geometric parameter calculated by the processor 110 comprises a volume of a bounding box associated with the 3D printing job; a volume of an object associated with the 3D printing job; and a volumetric surface area of the object associated with the 3D printing job. In such examples the processor may be to determine, for a first material of the one or more materials, based on a calculated value of the volume of the bounding box associated with the 3D printing job, an amount of the first material to be used by the additive manufacturing system to complete the 3D printing job. The first material may be, for example, a powdered build material, which fills the whole volume of the bounding box upon completion of the 3D printing job.

The processor 110 may further be to determine, for a second material of the one or more materials, based on a calculated value of the volume of the object associated with the 3D printing job, an amount of the second material to be used by the additive manufacturing system to complete the 3D printing job. The second material may be, for example, a fusing agent. A fusing agent is selectively deposited on regions of each layer of powdered build material in patterns based on the cross-section of each slice/layer of the object. Therefore the amount of fusing agent to be used to complete the 3D printing job will be proportional to the volume of the 3D object.

The processor 110 may further be to determine, for a third material of the one or more materials, based on a calculated value of the volumetric surface area of the object associated with the 3D printing job, an amount of the third material to be used by the additive manufacturing system to complete the 3D printing job. The third material may, for example, be a detailing agent. A detailing agent is deposited on linear regions of each layer of powdered build material which correspond to edges of the 3D object, therefore the amount of detailing agent to be used to complete the 3D printing job will be approximately proportional to the volumetric surface area of the 3D object. The linear regions in which the detailing agent is deposited may have a thickness (that is they may extend outwardly and/or inwardly from the external surface of the 3D object by a distance, which may depend on factors such as the type of the powdered build material and the shape of the 3D object). The thickness of the linear regions may vary for different parts of a given 3D object. The thickness of the linear regions may be in the range 0-2 mm. For example, a linear region adjacent an edge of a relatively thick part of the 3D object may have a thickness of 1.5 mm, whilst a linear region adjacent an edge of a relatively thin part of the 3D object may have a smaller thickness. The thickness of the linear region may thereby depend on the shape of the part of the 3D object which the linear region is adjacent to.

In some examples a detailing agent may be deposited within the volume of the 3D object, as well as being deposited adjacent the edges in the manner described above. For example, the detailing agent may be used to aid cooling of certain regions within the 3D object, to ensure an even temperature distribution within the 3D object during generation of the 3D object. In such examples the processor 110 may be to determine the amount of the third material to be used by the additive manufacturing system to complete the 3D printing job based on a calculated value of the volumetric surface area of the object associated with the 3D printing job and on a calculated volume associated with the object associated with the 3D printing job. For example, the calculated volume may be the volume of regions within the 3D object which are expected to become hotter during generation of the 3D object. The size and locations of such regions may be determinable, e.g. by the controller 110, based on the data associated with the 3D printing job and on at least one operational parameter to be used by the additive manufacturing system in completing the 3D printing job.

The particular manner in which a geometric parameter is calculated by the processor 100 may depend on the format of the data associated with the 3D printing job. For example, for data in a 3D “raster”-based format (e.g. series of voxels, octrees, quadtrees, or the like), calculating a geometric parameter may comprise counting the number of voxels (or octrees, quadtrees, etc.) in a 3D object or in a surface of a 3D object. For data in a 3D vector graphics format (e.g. triangular mesh), the volume and volumetric surface area of a 3D object can be computed directly using any one of various known techniques. For data in a 2D vector graphics format (e.g. stack of polygonal slices), calculating the volume of a 3D object may comprise computing the volume of each polygonal slice (e.g. by multiplying the area of the slice by the slice thickness) and adding together all the individual slice volumes. The area of a polygonal slice can be calculated using any suitable known technique, such as the shoelace formula. For data in a 2D vector graphics format (e.g. stack of polygonal slices), calculating the volumetric surface area of a 3D object may comprise (a) calculating a volumetric surface area for each slice (e.g. by multiplying a perimeter length of the slice by the slice thickness) and adding together all the individual slice surface areas, (b) calculating, in respect of each slice, a difference between the area of that slice and the area of a slice immediately below; and (c) adding together the results of (a) and (b). In all cases, the volume of a bounding box can be calculated by multiplying a cross-sectional area of a build chamber of the additive manufacturing system by a height of the at least one 3D object associated with the 3D printing job.

In some examples the processor 110 may be to determine an amount of the at least one material to be used by the additive manufacturing system to complete the 3D printing job by determining a value for a to-be-used amount of the at least one material per unit of the at least one geometric parameter, and multiplying the determined value by the calculated value of the at least one geometric parameter. For example, to determine a to-be-used amount of a powdered build material, the processor 110 may determine a value for a to-be-used weight of powdered build material per unit volume of a bounding box, and then multiply this determined weight value by a calculated volume of the particular bounding box associated with the 3D printing job. To determine a to-be-used amount of a fusing agent, the processor 110 may determine a value for a to-be-used volume of fusing agent per unit volume of a 3D object, and then multiply this determined volume value by a calculated volume of the particular 3D object(s) associated with the 3D printing job. To determine a to-be-used amount of a detailing agent, the processor 110 may determine a value for a to-be-used volume of detailing agent per unit volumetric surface area of a 3D object, and then multiply this determined volume value by a calculated volumetric surface area of the particular 3D object(s) associated with the 3D printing job. In some examples, to determine a to-be-used amount of a detailing agent the processor 110 may determine a value for a to-be-used volume of detailing agent per unit volume of a 3D region within the 3D object in which detailing agent is to be deposited (e.g. an expected hot region, as discussed above), and may determine a volume of such a 3D region within the 3D object. The processor 110 may then multiply the determined volume value by the determined volume of the 3D region, to determine an “in-object” amount of detailing agent to be deposited within the volume of the 3D object. The determined in-object amount may then be added to the “edge” amount resulting from the determination based on the volumetric surface area, to yield a total to-be-used amount of detailing agent.

The amount of a material to be used by the additive manufacturing system to complete the 3D printing job per unit of the at least one geometric parameter may depend on properties of the material (e.g. density, contraction factor (that is, how much the material contracts during curing), etc.). In the case of agents, the per-unit to-be-used amount of a material may also depend on the operational parameters to be used by the additive manufacturing system in completing the 3D printing job. Operational parameters which can affect the per unit to-be-used amount of an agent include the number of printing passes per layer of powdered build material (that is, the number of times an agent deposit mechanism passes over each deposited layer of powdered build material before the next layer of powdered build material is deposited), the density of the agent to be used in each pass, the melting behaviour of the powdered build material.

In some examples a per-unit to-be-used amount value for each of various combinations of material properties and operating parameters may be stored in a memory accessible by the processor 110, e.g. a memory of the controller 100. For example, a per unit to-be-used amount value may be stored in respect of each possible combination of materials and operating parameters potentially usable by the additive manufacturing system to generate a 3D object. Therefore, in some examples the processor 110 may be to determine a value for a to-be-used amount of the at least one material per unit of the at least one geometric parameter by retrieving the value from a memory of the controller.

In some examples, more of a given material may be to be used to complete a given 3D printing job than an amount of that material determined based on the geometric properties of a 3D object associated with the 3D printing job and not on factors relating to the operation of the additive manufacturing system to be used to perform the 3D printing job. This is because the additive manufacturing system may be configured to perform one or more servicing processes before, during and/or after generation of the 3D object, and performing such servicing processes may require an amount of the given material to be used in excess of the amount of that material used to generate the 3D object.

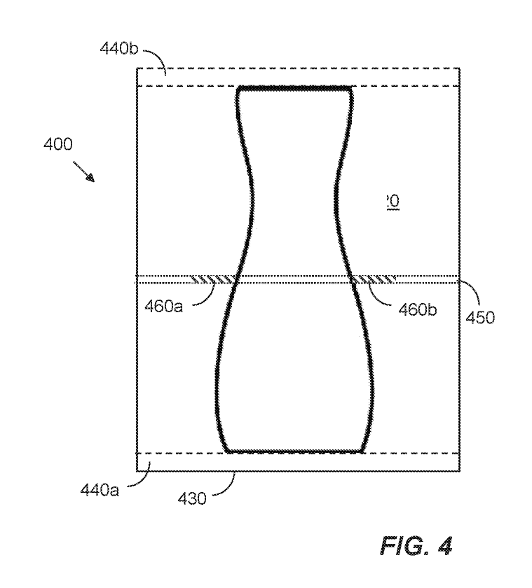

The properties of such servicing processes may be associated with one or more operational parameters of the additive manufacturing system. For example, in at least some operating modes an additive manufacturing system may deposit one or more “servicing” layers of powdered build material below the first layer to be comprised in a 3D object. Such layers may serve to warm up or otherwise prepare a deposit mechanism of the additive manufacturing system. Similarly, an additive manufacturing system may deposit one or more servicing layers of powdered build material above the final layer to be comprised in a 3D object. Such layers may, for example, serve to separate a first 3D object associated with a 3D printing job from a further 3D object associated with the same 3D printing job, and/or to reduce a cooling rate of the 3D object (e.g. to achieve annealing of the 3D object). Additionally or alternatively, an additive manufacturing system may deposit an agent in one or more “servicing” regions of a layer which will not be comprised in the 3D object. Such servicing regions may be adjacent to regions of the layer which will be comprised in the 3D object. Such servicing regions may serve to warm up or otherwise prepare an agent deposit mechanism of the additive manufacturing system. The layers and regions which may be associated with various possible servicing processes are illustrated by FIG. 4.

FIG. 4 shows a build chamber 400 of an additive manufacturing system (e.g. the additive manufacturing system 200), after generation of a 3D object 410 (before the 3D object has been removed from the build chamber). The build chamber 400 may have any of the features of the build chamber 300 as described above. The build chamber is filled to a height h by the 3D object 410 (which comprises fused powdered build material), by unfused powdered build material 420 surrounding the 3D object 410, and by sets of servicing layers 440a and 440b above and below the 3D object 410. In the particular example each set of servicing layers 440a, 440b comprises a plurality of layers of unfused powdered build material, however; in other examples a set of servicing layers may comprise a single layer of powdered build material, which may be unfused, fused or partially fused.

As described above, the powdered build material in the build chamber 400 is deposited as a plurality of layers, each of which has a predetermined height set by operating parameters of the additive manufacturing system. One such layer 450 is highlighted on FIG. 4, but it will be appreciated that a plurality of further layers are also present above and below the highlighted layer 450. Each of the further layers may have the some or all of the features of the layer 450. The layer 450 comprises two servicing regions 460a and 460b, which are located immediately upstream and immediately downstream of a region comprised in the 3D object 410, with respect to a direction of movement of an agent deposit mechanism of the additive manufacturing system. In other examples a single servicing region may be comprised in a given layer. Such a single servicing region may be located upstream of a region comprised in the 3D object, for example if the single servicing region is to warm up or otherwise prepare the agent deposit mechanism prior to depositing agent in a region which is to be comprised in the 3D object. Each layer of powdered build material which includes a region comprised in the 3D object may comprise a servicing region. Alternatively, at least one but not all of the layers of powdered build material which include a region comprised in the 3D object may comprise a servicing region. Any or all of a fusing agent, a detailing agent, and any other type of agent may be deposited in a given servicing region.

The total amount of a material to be used to complete the 3D printing job may therefore depend on servicing related operational parameters including: a number of layers comprised in a set of servicing layers to be used for the 3D printing job; a number of sets of servicing layers to be used for the 3D printing job; a number and configuration of in-layer servicing regions to be used for the 3D printing job. For some servicing processes (e.g. servicing processes performed before or after rather than during the generation of a 3D object), an amount of a material to be used to perform the servicing process may be independent of any particular details of a 3D object associated with the 3D printing job. For other servicing processes (e.g. servicing processes performed during the generation of a 3D object) an amount of a material to be used to perform the servicing process may depend on particular details (such as shape, size, colour, or the like) of a 3D object associated with the 3D printing job. For example, an in-layer servicing process which is performed in respect of each deposited layer will use an amount of material proportional to the height of the 3D object.

Therefore, in some examples, the controller 100 is configured to account for servicing processes in determining an amount of the at least one material to be used by the additive manufacturing system to complete the 3D printing job. In some such examples the processor 110 of the controller 100 is to determine an amount of a given material (i.e. an agent) to be used by the additive manufacturing system to complete the 3D printing job by determining a first value for a to-be-used amount of the given material per unit of volume or volumetric surface area of the 3D object associated with the 3D printing job, and multiplying the determined first value by a calculated volume or volumetric surface area (as appropriate, depending on the material) of the 3D object to generate a first amount (i.e. of the given material). The first amount may be an amount of the given material that would be used to generate the 3D object if no servicing processes were performed by the additive manufacturing system during completion of the 3D printing job.

In some examples the processor 110 may further be to determine a second value for a to-be-used amount of the given material per unit height of a 3D object to be generated, and to multiply the determined second value by a calculated height of the 3D object associated with the 3D printing job to generate a second amount (i.e. of the given material). The second amount may be an amount of the given material to be used for in-layer servicing processes to be performed by the additive manufacturing system during generation of the 3D object. The processor 110 may further be to add together the first amount and the second amount. The result of this addition may in some cases (e.g. cases in which no beginning or end servicing processes are performed) represent a total amount of the given material to be used by the additive manufacturing system to complete the 3D printing job.

In some examples the processor 110 may be to determine a third amount in respect of the given material. The third amount may be an amount of the given material to be used for servicing processes to be performed by the additive manufacturing system before and/or after generation of the 3D object, as part of completing the 3D printing job. The third amount may be determined based on at least one operational parameter to be used by the additive manufacturing system in completing the 3D printing job. The third amount may be determined independently of any geometric parameters associated with the 3D printing job. The processor 110 may further be to add together the first amount and the third amount. The sum of the first and third amounts may, in some cases (e.g. cases in which no in-layer servicing processes are performed) represent a total amount of the given material to be used by the additive manufacturing system to complete the 3D printing job. The processor 110 may be to add together the first amount, the second amount and the third amount. The sum of the first, second and third amounts may in some cases (e.g. cases in which both beginning/end servicing processes and in-layer servicing processes are performed) represent a total amount of the given material to be used by the additive manufacturing system to complete the 3D printing job.

In some examples in which the one or more materials comprises a recyclable powdered build material, the processor 110 may be to calculate a volume of a bounding box associated with the 3D printing job and a volume of an object associated with the 3D printing job. The processor may be to determine an amount of the recyclable powdered build material to be used by the additive manufacturing system to complete the 3D printing job (e.g. based on the volume of the bounding box, in the manner described above) and may further be to determine, based on the determined to-be-used amount of the recyclable powdered build material and on the calculated value of the volume of the object associated with the 3D printing job, an amount of the recyclable powdered build material that will be available for recycling after completion of the 3D printing job. For example, the processor 110 may be to determine an amount of recyclable powdered build material that will be comprised in the at least one 3D object, based on the calculated value of the volume of the at least one 3D object, and to subtract the result from the determined to-be-used amount of the recyclable powdered build material.

In a particular example in which the one or more materials for which to-be-used amounts are to be determined comprise a powdered build material, a fusing agent and a detailing agent, the following parameters may used by the processor 110 to determine to-be-used amounts of each material:
FusingProportional: The to-be-used amount of fusing agent per unit volume.
FusingByHeight: A height- (of the at least one 3D object associated with a print job) dependent correction factor which accounts for an amount of fusing agent to be used for in-layer servicing processes.
FusingFixed: A fixed (i.e. independent of any geometric details of the 3D object to be generated) correction factor which accounts for an amount of fusing agent to be used for beginning/end servicing processes.
DetailingPraportional: The to-be-used amount of detailing agent per unit volumetric surface area.
DetailingByHeight: A height-dependent correction factor which accounts for an amount of detailing agent to be used for in-layer servicing processes.
DetailingFixed: A fixed correction factor which accounts for an amount of detailing agent to be used for beginning/end servicing processes.
PowderByHeight: The to-be-used amount of powdered build material per unit height (of the at least one 3D object associated with the 3D printing job).
PowderFixed: A fixed correction factor which accounts for an amount of powdered build material to be used for beginning/end servicing processes.

The values of each of these parameters may depend on operational parameters of the additive manufacturing system, as discussed above. The values of each of these parameters may therefore be specific to a given 3D printing job.

In the particular example, the processor 110 may be to determine a to-be-used amount R of each material using the following:

R_{fusing agent}=(3D object volume×FusingProportional)+(3D object height×FusingByHeight)+FusingFixed (Equation 1)

R_{detailing agent}=(3D object volumetric surface area×DetailingProportional)+(3D object height×DetailingByHeight)+DetailingFixed (Equation 2)

R_{build material}=(3D object height×PowderByHeight)+PowderFixed (Equation 3)

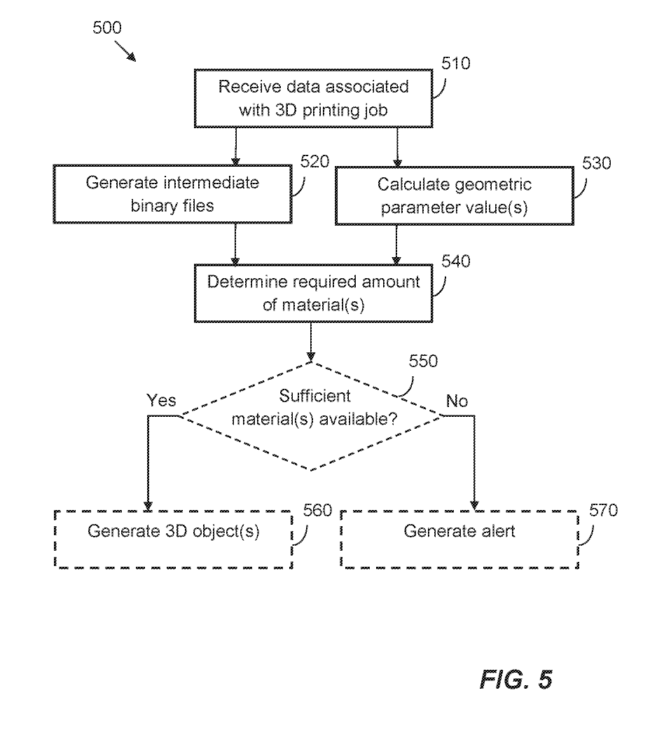

FIG. 5 is a flow chart that implements an example of a method 500 for determining an amount of at least one material to be used by an additive manufacturing system (e.g. the additive manufacturing system 200) to complete a 3D printing job. The method 500 may be performed, for example, by a controller (e.g. the controller 100) of this disclosure. In some examples at least one block of the method 500 may be encoded as one or a plurality of machine readable instructions stored on a memory accessible by a controller of this disclosure. In discussing FIG. 5 reference is made to the diagrams of FIGS. 1-4 to provide contextual examples. Implementation, however, is not limited to those examples.

The method 500 includes receiving data associated with a 3D printing job (block 510). The data may have any of the features described above in relation to the operation of the controller 100, and may be received in any suitable manner. For example, the data may comprise at least one 3MF package file. The method further includes generating (e.g. by the processor 110) intermediate binary files based on the received data (block 520). In some examples, generating intermediate binary files may comprise parsing at least one file (e.g. a 3MF package file comprised in the received data) to extract slice-stack representations of the or each 3D object associated with the 3D printing job. Generating intermediate binary files may comprise saving extracted slice-stack representations as binary files. In some examples generating intermediate binary files may comprise saving a 3D object model (e.g. comprising a polygonal mesh) as binary files. In some examples, the data may be further processed following the generation of the intermediate binary files, for example to generate control data for the deposit mechanisms of the additive manufacturing system. Such processing may comprise volumetric rendering of the at least one 3D object. Generated control data may be stored, e.g. in a memory of the additive manufacturing system, until generation of the at least one 3D object is initiated.

The method 500 also includes calculating a value of at least one geometric parameter associated with the 3D printing job, based on the received data (block 530). The at least one geometric parameter may have any of the features described above, and may be calculated in any of the manners described above in relation to the operation of the controller 100. Block 530 may be performed simultaneously with block 520. Alternatively, block 530 may be performed after block 520.

The method 500 also includes determining, for at least one material to be used to complete the 3D printing job, an amount of the at least one material to be used by the additive manufacturing system to complete the 3D printing job (block 540). The determining may be based on an operational parameter to be used by the additive manufacturing system in completing the 3D printing job, and on a value of at least one geometric parameter associated with the 3D printing job, which may be calculated/determined as described above in relation to the operation of the controller 100. Determining a to-be-used amount of the at least one material may be performed in any of the manners described above in relation to the operation of the controller 100.

In some examples the method 500 may also include a block 550, in which it is determined (e.g. by the controller 100) whether a sufficient amount of the at least one material is available to the additive manufacturing system to complete the 3D printing job. Performing block 550 may comprise determining, in any suitable manner, an amount of a material available to the additive manufacturing system. Performing block 550 may further comprise determining, in any suitable manner, whether the determined amount of the at least one material available to the additive manufacturing system is less than an amount of the at least one material determined by the additive manufacturing system to be used to complete the 3D printing job.

If it is determined in block 550 that the determined amount of the material available to the additive manufacturing system is not less than the amount of that material determined by the additive manufacturing system to be used to complete the 3D printing job, then in block 560 the at least one 3D object may be generated. Performing block 560 may comprise the controller 100 causing (e.g. by sending a control signal to a deposit mechanism) the additive manufacturing system to generate the at least one 3D object. Performing block 560 may comprise a user initiating generation of the at least one 3D object.

If it is determined in block 550 that the determined amount of the material available to the additive manufacturing system is less than the amount of that material determined by the additive manufacturing system to be used to complete the 3D printing job, then in block 570 an alert is generated. The alert may comprise, for example, a warning message displayed on a user interface of the additive manufacturing system. Generating the alert may comprise activating a visual or aural alarm, such as a warning sound or light.

In some examples (not illustrated) in which the material in respect of which the determination in block 540 is performed is a powdered build material, the method 500 may further include controlling a build material processing station to provide the determined to-be-used amount of powdered build material to the additive manufacturing system. Providing the determined to-be-used amount of powdered build material to the additive manufacturing system may comprise providing the to-be-used amount of powdered build material to a powdered build material supply mechanism of the additive manufacturing system. In some examples providing the determined to-be-used amount of powdered build material to the additive manufacturing system may comprise the build material processing station providing an amount of powdered build material to an intermediate component which may be moveable between the build material processing station and the additive manufacturing system, such as a trolley.

In some such examples, controlling a build material processing station to provide the determined to-be-used amount of powdered build material to the additive manufacturing system may comprise determining an amount of powdered build material available to the additive manufacturing system and calculating a difference between the available amount of powdered build material and the determined to-be-used amount of powdered build material. The calculated difference may correspond to a shortfall amount of powdered build material. Controlling the build material processing station to provide the determined to-be-used amount of powdered build material to the additive manufacturing system may, in such examples, comprise controlling the build material processing station to deliver an amount of powdered build material greater than or equal to the calculated shortfall amount to the additive manufacturing system.

The method 500 may be performed in respect of one, some or all of the materials to be used in completing a given 3D printing job. In examples in which the method 500 is to be performed in respect of more than one material, the method 500 may be performed for two or more materials simultaneously, or may be performed sequentially (i.e. such that it is performed in respect of a first material, and is then performed in respect of a second material).

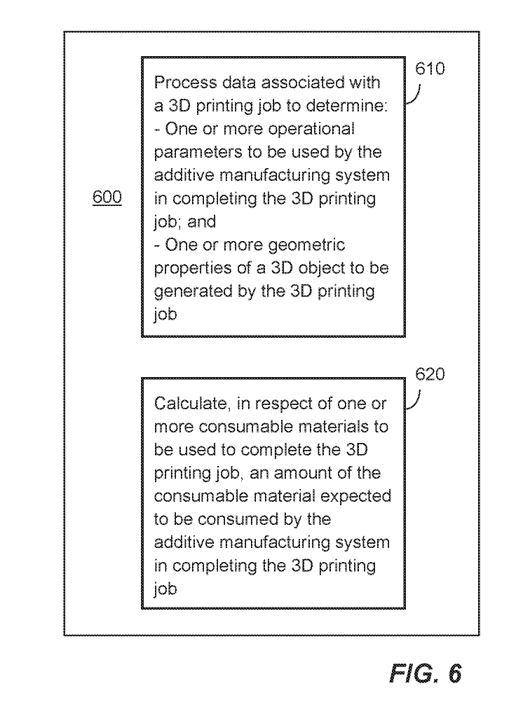

As mentioned above, in some examples at least part of a method of this disclosure may be encoded as one or a plurality of machine readable instructions stored on a memory accessible by a controller of a printing device of this disclosure. FIG. 6 shows an example non-transitory machine readable storage medium 600 encoded with instructions executable by a processor, e.g. the processor 100. The machine-readable storage medium 600 comprises instructions 610 to cause an additive manufacturing system to process data associated with a 3D printing job to determine: one or more operational parameters to be used by the additive manufacturing system in completing the 3D printing job; and one or more geometric properties of a 3D object to be generated by the 3D printing job. The machine-readable storage medium 600 further comprises instructions 620 to cause an additive manufacturing system to calculate, in respect of one or more consumable materials to be used to complete the 3D printing job, an amount of the consumable material expected to be consumed by the additive manufacturing system in completing the 3D printing job. In some examples the machine readable storage medium 600 may further include instructions to cause an additive manufacturing system to determine whether a sufficient amount of the one or more consumable materials is available to the additive manufacturing system to complete the 3D printing job.

In an example an additive manufacturing system for generating a 3D object based on print data, using a manufacturing substance (which may be, for example, a powdered build material, a fusing agent, a detailing agent, a colorant, or the like), comprises a processing unit (which may be the controller 100 or the processor 110). The processing unit is to receive print data associated with a 3D object to be generated, the print data comprising information relating to properties of the 3D object and information relating to a print mode to be used to generate the 3D object. The processing unit is further to calculate, based on the information relating to properties of the 3D object, one or more of: a volume of the 3D object and a volumetric surface area of the 3D object. The processing unit is further to calculate, based on the calculated volume or volumetric surface area and on the information relating to a print mode, an amount of the manufacturing substance to be used to generate the 3D object.

The examples described herein may provide advantageous effects. Certain examples described herein enable an amount of consumable materials to be used by a given 3D printing job to be estimated before generation of a 3D object is started. This may facilitate, for example, unattended 3D printing. Moreover, the estimation may in some examples be performed in parallel with other processing to be performed on data associated with the 3D printing job in order to start generation of a 3D object, so that additional time overhead is not incurred by the estimating.

In the foregoing description, numerous details are set forth to provide an understanding of the examples disclosed herein. However, it will be understood that the examples may be practiced without these details. While a limited number of examples have been disclosed, numerous modifications and variations therefrom are contemplated. It is intended that the appended claims cover such modifications and variations. Claims reciting “a” or “an” with respect to a particular element contemplate incorporation of at least one such element, neither requiring nor excluding two or more such elements. Further, the terms “include” and “comprise” are used as open-ended transitions.

What is claimed is:

1. A controller for an additive manufacturing system, the controller comprising a processor to:
receive data associated with a 3D printing job, the 3D printing job being to generate at least one 3D object using one or more materials;
determine, based on the received data, at least one operational parameter to be used by the additive manufacturing system in completing the 3D printing job;
calculate, based on the received data, a value of at least one geometric parameter associated with the 3D printing job; and
for at least one of the one or more materials, determine, based on the determined at least one operational parameter and the calculated value of the at least one geometric parameter, an amount of the at least one material to be used by the additive manufacturing system to complete the 3D printing job.

2. A controller according to claim 1:
the at least one geometric parameter comprising at least one of: volume of a bounding box associated with the 3D printing job; volume of an object associated with the 3D printing job; volumetric surface area of an object associated with the 3D printing job;
the at least one operational parameter comprising at least one of: build material type, operating mode; number of passes by layer; density of a given material used in each pass; layer height; volume associated with print head maintenance; and
the at least one material comprising at least one of: a powdered build material; a fusing agent; a detailing agent; a colorant.

3. A controller according to claim 1, the processor being to determine an amount to be used by the additive manufacturing system to complete the 3D printing job of each of the one or more materials.

4. A controller according to claim 1, the processor further being to:
determine an amount of the at least one material available to the additive manufacturing system for use in performing a 3D printing job;
determine whether the determined amount of the at least one material available to the additive manufacturing system is less than an amount of the at least one material determined to be required by the additive manufacturing system to complete the 3D printing job; and
if the determined amount of the at least one material available to the additive manufacturing system is less than the amount of the at least one material determined to be to be used by the additive manufacturing system to complete the 3D printing job, generate an alert.

5. A controller according to claim 4, the processor further being to:
if the determined amount of the at least one material available to the additive manufacturing system is not less than the amount of the at least one material determined to be used by the additive manufacturing system to complete the 3D printing job, cause the additive manufacturing system to generate the at least one 3D object.

6. A controller according to claim 1, wherein the at least one material comprises a plurality of materials and wherein at least one geometric parameter comprises a volume of a bounding box associated with the 3D printing job; a volume of an object associated with the 3D printing job; and a volumetric surface area of the object associated with the 3D printing job, the processor being to:
for a first material of the plurality of materials, determine, based on a calculated value of the volume of the bounding box associated with the 3D printing job, an amount of the first material by the additive manufacturing system to complete the 3D printing job; and
for a second material of the plurality of materials, determine, based on a calculated value of the volume of the object associated with the 3D printing job, an amount of the second material to be used by the additive manufacturing system to complete the 3D printing job; and
for a third material of the plurality of materials, determine, based on a calculated value of the volumetric surface area of the object associated with the 3D printing job, an amount of the third material to be used by the additive manufacturing system to complete the 3D printing job.

7. A controller according to claim 6, the first material being a powdered build material, the second material being a fusing agent and the third material being a detailing agent.

8. A controller according to claim 1, the processor being to determine a “to-be-used” amount of the at least one material to be used by the additive manufacturing system to complete the 3D printing job by determining a value for a to-be-used amount of the at least one material per unit of the at least one geometric parameter, and multiplying the determined value by the calculated value of the at least one geometric parameter.

9. A controller according to claim 8, the processor being to determine a value for a to-be-used amount of the at least one material per unit of the at least one geometric parameter by retrieving the value from a memory of the controller.

10. A controller according to claim 1, wherein the at least one geometric parameter comprises a first geometric parameter and a second geometric parameter, the first geometric parameter comprising a volume of an object associated with the print job or a volumetric surface area of an object associated with the print job and the second geometric parameter comprising a height of the object associated with the print job, the processor being to determine a “to-be-used” amount of the at least one material to be used by the additive manufacturing system to complete the 3D printing job by:
determining a first value for a to-be-used amount of the at least one material per unit of the first geometric parameter, and multiplying the determined first value by the calculated value of the first geometric parameter to generate a first amount;
determining a second value for a to-be-used amount of the at least one material per unit of the second geometric parameter, and multiplying the determined second value by the calculated value of the second geometric parameter to generate a second amount; and
adding together the first amount and the second amount.

11. A controller according to claim 10, the processor being to determine a to-be-used amount of the at least one material to be used by the additive manufacturing system to complete the 3D printing job by:
determining a third amount of the at least one material; and
adding together the first amount, the second amount, and the third amount.

12. A controller according to claim 10, the first amount being an amount of the at least one material that would be used to generate the at least one 3D object if no servicing processes were performed by the additive manufacturing system during completion of the 3D printing job, the second amount being an amount of the at least one material to be used for in-layer servicing processes to be performed by the additive manufacturing system during generation of the 3D object, and the third amount being an amount of the at least one material to be used for servicing processes to be performed by the additive manufacturing system before and/or after generation of the at least one 3D object, as part of completing the 3D printing job.

13. A controller according to claim 1, wherein the at least one geometric parameter comprises a volume of a bounding box associated with the 3D printing job and a volume of an object associated with the 3D printing job, and wherein the one or more materials comprises a recyclable powdered build material, the processor being to:
determine, based on a calculated value of the volume of the bounding box associated with the 3D printing job, a “to-be-used” amount of the recyclable powdered build material to be used by the additive manufacturing system to complete the 3D printing job; and
determine, based on the determined to-be-used amount of the recyclable powdered build material and on a calculated value of the volume of the object associated with the 3D printing job, an amount of the recyclable powdered build material available for recycling after completion of the 3D printing job.

14. An additive manufacturing system for generating a 3D object based on print data, using a manufacturing substance, the additive manufacturing system comprising a processing unit to:
receive print data associated with a 3D object to be generated, the print data comprising information relating to properties of the 3D object and information relating to a print mode to be used to generate the 3D object;
calculate, based on the information relating to properties of the 3D object, one or more of: a volume of the 3D object and a volumetric surface area of the 3D object; and
calculate, based on the calculated volume or volumetric surface area and on the information relating to a print mode, an amount of the manufacturing substance to be used to generate the 3D object.

15. A computer readable memory encoded with instructions to cause an additive manufacturing system to:
process data associated with a 3D printing job to determine:
one or more operational parameters to be used by the additive manufacturing system in completing the 3D printing job; and
one or more geometric properties of a 3D object to be generated by the 3D printing job; and
calculate, in respect of one or more consumable materials to be used to complete the 3D printing job, an amount of the consumable material expected to be consumed by the additive manufacturing system in completing the 3D printing job.
